(19) United States
(12) Patent Application Publication
(10) Pub. No.: US 2026/0057405 A1
(43) Pub. Date: Feb. 26, 2026

(54) METHOD AND SYSTEM FOR PROVIDING NFT-LINKED GIFT CERTIFICATE SERVICE

(71) Applicant: WEVERSE COMPANY INC., Seongnam-si, Gyeonggi-do (KR)

(72) Inventor: Sang Il SIM, Seongnam-si, Gyeonggi-do (KR)

(73) Assignee: WEVERSE COMPANY INC., Seongnam-si, Gyeonggi-do (KR)

(21) Appl. No.: 18/879,671

(22) PCT Filed: Jun. 8, 2023
(86) PCT No.: PCT/KR2023/007886

§ 371 Date: Dec. 27, 2024

(30) Foreign Application Priority Data
Jun. 27, 2022 (KR) 10-2022-0078266

(51) Int. Cl. G06Q 30/0207; G07C 13/00

(52) U.S. Cl. CPC G06Q 30/0212; G07C 13/00

(57) ABSTRACT

A method for providing an NFT-linked gift certificate service, according to an embodiment of the present disclosure, which is a method in which an application executed by at least one processor of a terminal provides an NFT-linked gift certificate service, includes: performing a survey to determine a target artist for which a gift certificate is matched; generating a content gift certificate matched with a pair of NFTs containing digital content for the determined target artist; providing the generated content gift certificate in a random manner; acquiring gift certificate identification information specifying a predetermined first gift certificate; determining whether the first gift certificate is the content gift certificate based on the acquired gift certificate identification information; and when the first gift certificate is the content gift certificate, providing the pair of NFTs matched to the content gift certificate online.

### DESCRIPTION

### Technical Field

The present disclosure relates to a method and system for providing an NFT-linked gift certificate service. More specifically, the present disclosure relates to a method and system for providing an NFT-linked gift certificate service that links an NFT including artist-related content to a gift certificate including a portrait of an artist.

### Background Art

Recently, as part of economic development and active leisure life, the general public's interest in entertainers has been increasing significantly. Above all, as part of a marketing technique, the people involved are generating a lot of revenue by selling goods that use the brand value of entertainers with high star potential.

The scope of application of these goods has expanded, and is now being applied not only to goods mainly purchased by fans, such as cheering sticks and bromides, but also to goods purchased by the general public, such as various foods, cosmetics, and gift certificates.

However, specially-made goods that include photos of entertainers and artists may have different versions or printing on the outside of a product compared to general goods, which may give consumers the impression that the specially-made goods are different from general goods. In addition, since the manufacturing period of the goods may be inferred based on a model contract period, these goods may be rather turned away from consumers who want recently manufactured general goods rather than specially-made goods.

In addition, even when the company that produces the goods takes into account the size and popularity of fans, when the actual demand is more or less than expected, the company needs to produce more goods or discard the goods that have been manufactured. This results in additional unexpected production costs or losses equivalent to the number of surplus goods.

With the recent groundbreaking development of blockchain technology, the utilization of non-fungible tokens (NFTs) based thereon is expanding into various fields.

In particular, in the artistic field, the NFT is a technology that is being utilized in various ways to add value to digital content, thereby greatly contributing to market activation.

The NFTs have been used to prove ownership of digital assets within the virtual world of the metaverse. However, for the general public who are not yet familiar with the metaverse, ownership of digital assets through the NFTs often feels like an illusion.

In addition, there is a disadvantage that the symbolism and rarity of NFTs distributed within the platform may be reduced due to the indiscriminate issuance of NFTs, and thus the need for a new invention that links the goods and NFTs is emerging to address the aforementioned issue.

### DETAILED DESCRIPTION OF INVENTION

### Technical Problems

The present disclosure has been devised to obviate the above limitation of the related art. An aspect of the present disclosure is directed to providing a method and system for providing an NFT-linked gift certificate service that grafts an NFT onto visible actual assets.

In addition, an aspect of the present disclosure is directed to providing a method and system for providing an NFT-linked gift certificate service that issues a limited number of gift certificates (goods) according to demand.

In addition, an aspect of the present disclosure is directed to providing a method and system for providing an NFT-linked gift certificate service that randomly provides the issued gift certificate and provides a management service based thereon.

In addition, an aspect of the present disclosure is directed to providing a method and system for providing an NFT-linked gift certificate service that easily understands and manages the owner of an issued NFT.

In addition, an aspect of the present disclosure is directed to providing a method and system for providing an NFT-linked gift certificate service that prevents the indiscriminate generation of NFTs.

### Technical Solution

A method for providing an NFT-linked gift certificate service, according to an embodiment of the present disclosure, which is a method in which an application executed by at least one processor of a terminal provides the NFT-linked gift certificate service, includes: performing a survey to determine a target artist for which a gift certificate is matched; generating a content gift certificate matched with a pair of NFTs containing digital content for the determined target artist; providing the generated content gift certificate in a random manner; acquiring gift certificate identification information specifying a predetermined first gift certificate; determining whether the first gift certificate is the content gift certificate based on the acquired gift certificate identification information; and providing the pair of NFTs matched to the content gift certificate online when the first gift certificate is the content gift certificate.

In this connection, the content gift certificate is an actual gift certificate in which a serial number that specifies the content gift certificate matches a preset special number.

In addition, the generation of the content gift certificate matched with the pair of NFTs containing the digital content for the determined target artist includes setting a special gift certificate to which the special number is given, and matching the pair of NFTs to the special number of the set special gift certificate.

In addition, the matching of the pair of NFTs includes randomly selecting one of a plurality of pieces of digital content for the target artist, and generating the pair of NFTs based on the randomly selected digital content.

In addition, the performance of the survey to determine the target artist for which the gift certificate is matched includes: acquiring a user input to vote for at least one artist among a plurality of candidate artists; determining at least one candidate artist whose vote count according to the user vote satisfies a predetermined criterion as a selected artist; and determining one of the at least one selected artist as the target artist.

In addition, the provision of the generated content gift certificate in a random manner includes: verifying a user who voted for the target artist; and randomly providing at least gift certificate among the content gift certificates matched with the pair of NFTs and a general gift certificate unmatched with the pair of NFTs upon being verified as the user who voted for the target artist.

In addition, the provision of the pair of NFTs matched to the content gift certificate online when the first gift certificate is the content gift certificate includes: matching the provided pair of NFTs to a user account; and setting ownership information for the pair of NFTs based on the pair of NFTs matched to the user account.

In addition, the method for providing the NFT-linked gift certificate service according to an embodiment of the present disclosure further includes providing an exchange process for processing a transaction or use of the content gift certificate.

In addition, the provision of the exchange process includes changing or discarding the ownership information for the pair of NFTs matched to the traded or used content gift certificate.

In addition, the method for providing the NFT-linked gift certificate service according to an embodiment of the present disclosure further includes providing a new NFT based on a plurality of content gift certificates, wherein the provision of the new NFT includes at least one of: determining whether a preset new NFT reward condition is satisfied; maintaining a plurality of a pair of NFTs according to the plurality of content gift certificates and providing an additional NFT that is provided when the new NFT reward condition is satisfied; or deleting the plurality of the pair of NFTs and providing an higher-level NFT that is provided.

In addition, the additional NFT includes digital content for a target artist that matches at least some of the plurality of content gift certificates, and the higher-level NFT includes digital content in which at least one component of a pair of NFTs that matches at least some of the plurality of content gift certificates is upgraded.

A system for providing an NFT-linked gift certificate service according to an embodiment of the present disclosure includes: at least one memory in which a platform application is stored; and at least one processor for reading out the platform application stored in the memory and providing the NFT-linked gift certificate service, wherein instructions of the platform application include instructions for: performing a survey to determine a target artist for which a gift certificate is matched; generating a content gift certificate matched with a pair of NFTs containing digital content for the determined target artist; providing the generated content gift certificate in a random manner; acquiring gift certificate identification information specifying a predetermined first gift certificate; determining whether the first gift certificate is the content gift certificate based on the acquired gift certificate identification information; and providing the pair of NFTs matched to the content gift certificate online when the first gift certificate is the content gift certificate.

### Effect of Invention

A method and system for providing an NFT-linked gift certificate service according to an embodiment of the present disclosure can instill in consumers the perception that an NFT is not intangible data without substance by grafting the same onto a visible actual asset, thereby enhancing consumers' interest and curiosity in the NFT and actual assets, and simultaneously lowering the barrier to the NFT, thereby increasing the NFT transaction rate and activating the NFT market.

In addition, the method and system for providing the NFT-linked gift certificate service according to an embodiment of the present disclosure can implement a differentiated user reward paradigm by providing a predetermined actual asset including a predetermined NFT to a user.

In addition, the method and system for providing the NFT-linked gift certificate service according to an embodiment of the present disclosure can increase environmental/financial efficiency in the production of goods by issuing a limited number of gift certificates according to demand, thereby preventing additional expenses and losses that may occur due to unnecessary production of fewer or more.

In addition, the method and system for providing the NFT-linked gift certificate service according to an embodiment of the present disclosure can easily understand and manage the owner of the issued NFT, thereby enabling prompt response in the event of issues such as changes in the status of the issued NFT and/or copyright disputes in the future.

In addition, the method and system for providing the NFT-linked gift certificate service according to an embodiment of the present disclosure can prevent destruction of the analog and digital environment by blockchain mining equipment and blockchain facilities by avoiding indiscriminate generation of NFTs, and maintain excellent quality of NFTs, thereby enhancing reliability in the NFT market.

### BRIEF DESCRIPTION OF THE DRAWING

FIG. 1 is a conceptual diagram illustrating a system for providing an NFT-linked gift certificate service according to an embodiment of the present disclosure.

FIG. 2 is an internal block diagram illustrating a terminal according to an embodiment of the present disclosure.

FIG. 3 is a flowchart illustrating a method for issuing an NFT according to an embodiment of the present disclosure.

FIG. 4 is a diagram illustrating an example of a content gift certificate according to an embodiment of the present disclosure.

FIG. 5 is a flowchart illustrating a method for providing an NFT-linked gift certificate service according to an embodiment of the present disclosure.

FIG. 6 is an example of a gift certificate collecting interface according to an embodiment of the present disclosure.

FIG. 7 is an example of a diagram illustrating a content gift certificate exchange process according to an embodiment of the present disclosure.

FIG. 8 is an example of a diagram illustrating a method for providing a new NFT according to an embodiment of the present disclosure.

FIG. 9 is an example of artist digital content according to an embodiment of the present disclosure.

### BEST MODE FOR CARRYING OUT THE INVENTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

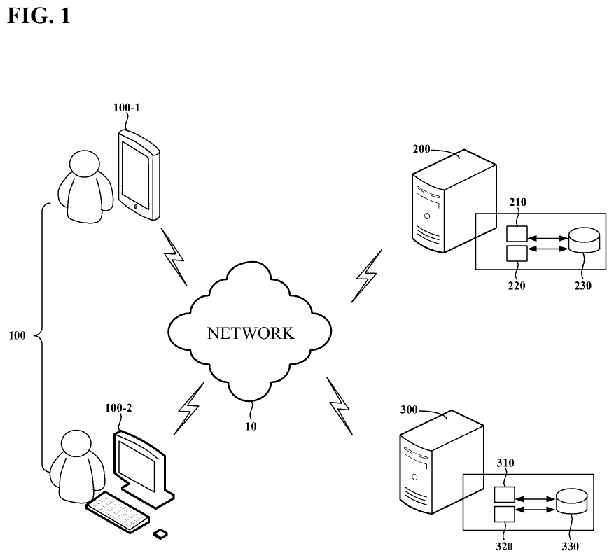

FIG. 1 is a conceptual diagram illustrating a system for providing an NFT-linked gift certificate service according to an embodiment of the present disclosure.

Referring to FIG. 1 the system for providing the NFT-linked gift certificate service according to an embodiment of the present disclosure (hereinafter, a “service provision system”) may provide the NFT-linked gift certificate service (hereinafter, “NFT-linked gift certificate service”) that links an NFT including artist-related content to a gift certificate including an artist portrait.

In an embodiment, the gift certificate may be a certificate that may be exchanged for goods and/or services equivalent to the face value, including a predetermined image associated with a predetermined object (for example, a specific artist) and predetermined unique identification information that specifies the gift certificate (for example, a serial number).

In addition, in an embodiment, the gift certificates may be classified into general gift certificates and special gift certificates based on the unique identification information. In this connection, the special gift certificate according to an embodiment may be linked to the NFT, and the special gift certificate linked to the NFT may be referred to as a content gift certificate.

In an embodiment, the NFT is a virtual certificate of authenticity that indicates unique originality and ownership by including an address indicating a digital file such as an image, video, and/or audio of a predetermined object (for example, specific artist individuals and/or groups) in a token, and may be a digital good for the predetermined object.

Herein, the NFT according to an embodiment may include NFT media data, NFT metadata, and/or NFT smart contract data.

The NFT media data is original data containing predetermined digital content, and may be referred to as artist digital content hereinafter.

Herein, the artist digital content according to an embodiment refers to content in which text, audio (sound source), images and/or videos about a predetermined artist are digitally combined, and each element has at least one type, so that various combinations of unique artist digital content may be generated. In an embodiment, the artist digital content may refer to, for example, an artist photo included in a digital photo card.

In addition, NFT metadata includes data related to the original data, such as description information, generator information, and storage address information.

In addition, the NFT smart contract data is data related to artist digital content as assets, including owner information, transaction history information, condition information, and price information.

In addition, hereinafter, the NFT metadata and NFT smart contract data may be collectively referred to as NFT detailed data.

In an embodiment, these NFTs may each be configured of a different combination of artist digital content and thus have unique characteristics.

In addition, in an embodiment, these NFTs may be issued in limited numbers for each artist.

In an embodiment, the service provision system implementing the NFT-linked gift certificate service as described above may be connected through a terminal 100, a service platform server 200, an external server 300, and a network 10.

Herein, the network 10 according to an embodiment refers to a connection structure capable of exchanging information between nodes such as the terminal 100, the service platform server 200 and/or the external server 300. Examples of the network 10 include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the terminal 100, the service platform server 200, and the external server 300 implementing the service provision system will be described in detail with reference to the attached drawings.

### Terminal 100

The terminal 100 according to an embodiment of the present disclosure may be a predetermined computing device having a platform application (hereinafter, an “application”) installed that provides the NFT-linked gift certificate service.

Specifically, from a hardware point of view, the terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the NFT-linked gift certificate service based on wired/wireless communication such as a fixed-type desktop PC, a laptop computer, and a personal computer such as an ultrabook in which the application is installed.

In addition, according to an embodiment, the terminal 100 may further include a predetermined server computing device that provides an NFT-linked gift certificate service environment.

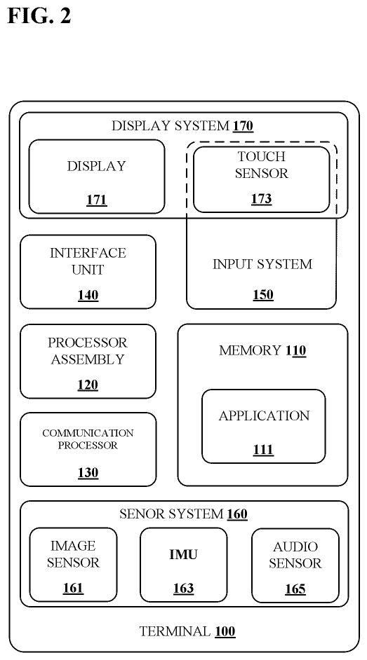

FIG. 2 is an internal block diagram of the terminal 100 according to an embodiment of the present disclosure.

Referring to FIG. 2, from a functional point of view, the terminal 100 may include a memory 110, a processor assembly 120, a communication processor 130, an interface module 140, an input system 150, a sensor system 160, and a display system 170. These components may be configured to be included within a housing of the terminal 100.

Specifically, the memory 110 may store an application 111, and the application 111 may store one or more of various application programs, data, and instructions for providing the NFT-linked gift certificate service environment.

In other words, the memory 110 may store commands and data used for generating the NFT-linked gift certificate service environment.

In addition, the memory 110 may include a program area and a data area.

Herein, the program area according to an embodiment may be linked between an operating system (OS) for booting the terminal 100 and functional elements, and the data area may store data generated according to the use of the terminal 100.

In addition, the memory 110 may include at least one non-transitory computer-readable storage medium and a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for generating the NFT-linked gift certificate service environment.

In an embodiment, the processor assembly 120 may control the overall operation of components through the application 111 of the memory 110 in order to provide the NFT-linked gift certificate service.

The processor assembly 120 may be a system-on-chip (SOC) suitable for the terminal 100 that includes a central processing unit (CPU) and/or graphics processing unit (GPU), may execute the OS and/or an application program stored in the memory 110, and control each component mounted on the terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with the terminal 100 storing a content source for implementing the NFT-linked gift certificate service environment, and may communicate with various user input components such as a controller receiving a user input.

In an embodiment, the communication processor 130 may transmit/receive various pieces of data related to the NFT-linked gift certificate service to/from another terminal 100 and/or an external server.

This communication processor 130 may wirelessly transmit and receive data with at least one of a base station, an external terminal 100, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the terminal 100.

In an embodiment, the image sensor 161 may capture and acquire various images and/or videos related to the NFT-linked gift certificate service.

In an embodiment, the image sensor 161 may acquire a captured image of an actual ticket image and/or a user personal image.

In addition, the image sensor 161 may be disposed on the front or/and rear side of the terminal 100 to acquire an image by capturing the disposed direction side, and may capture a physical space through a camera disposed toward the outside of the terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image obtained through the image sensor device using an image processing module to extract necessary information, and transmit the extracted information to a processor.

The image sensor 161 may be a camera assembly including at least one or more cameras. The camera assembly may include a general camera that captures a visible light band, and may further include a special camera such as an infrared camera or a stereo camera.

In addition, the aforementioned image sensor 161 may be operated while being included in the terminal 100 according to an embodiment, or may be included in an external device (for example, an external server) to operate through interworking based on the aforementioned communication processor 130 and/or interface module 140.

The IMU 163 may sense at least one of motion and acceleration of the terminal 100. For example, the IMU 163 may include a combination of various position sensors such as an accelerometer, a gyroscope, and a magnetometer.

In addition, the IMU may interwork with the position communication processor 130 such as GPS of the communication processor 130 to recognize spatial information on the physical space around the terminal 100.

The audio sensor 165 may recognize a sound around the terminal 100.

In detail, the audio sensor 165 may include a microphone capable of sensing a speech input of a user using the terminal 100.

In an embodiment, the audio sensor 165 may receive speech data necessary for the NFT-linked gift certificate service from a user.

The interface module 140 may communicatively connect the terminal 100 with one or more other devices. Specifically, the interface module 140 may include wired and/or wireless communication devices that are compatible with one or more different communication protocols.

The terminal 100 may be connected to various input/output devices through the interface module 140.

For example, the interface module 140 may be connected to an audio output device such as a headset port or a speaker to output audio.

Although it has been described as an example that the audio output device is connected through the interface module 140, an embodiment in which the audio output device is installed in the terminal 100 may also be included.

In addition, for example, the interface module 140 may be connected to an input device such as a keyboard and/or mouse to acquire a user input.

This interface module 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, a gesture, a speech command, operation of a button, or other type of input) related to the NFT-linked gift certificate service.

Specifically, the input system 150 may include a predetermined button, a touch sensor, and/or an image sensor 161 that receives a user motion input.

In addition, the input system 150 may be connected to an external controller through the interface module 140 to receive a user input.

The display system 170 may output various pieces of information related to the NFT-linked gift certificate service as a graphic image.

In an embodiment, the display system 170 may display various user interfaces for the NFT-linked gift certificate service (as an example, a gift certificate collecting interface and/or a general gift certificate use interface).

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or integrally formed to be implemented as a touch screen. Such a touch screen may function as a user input unit that provides an input interface between the terminal 100 and the user, and may provide an output interface between the terminal 100 and the user.

The terminal 100 including the aforementioned components may store at least one piece of artist information in the memory 110 according to an embodiment.

Herein, the artist information according to an embodiment may be information including an artist (group) name, at least one artist image, and numbers related to an artist (for example, the birthday of the artist and/or the debut date of the artist). Hereinafter, for convenience of explanation, the term “artist” may be used to encompass both individual artists and group artists.

In addition, in an embodiment, the terminal 100 may store at least one piece of artist digital content in the memory 110.

Herein, in an embodiment, the artist information and artist digital content stored in the memory 110 may be stored in a one-to-many relationship in which a plurality of pieces of artist digital content is stored per one piece of artist information for the same artist.

As such, in an embodiment, the artist digital content stored and matched with artist information may be randomly extracted and included in a predetermined NFT, and a detailed description thereof will be provided later.

In addition, in an embodiment, the terminal 100 may conduct a predetermined survey to issue a gift certificate based on at least one piece of artist information.

In addition, in an embodiment, the terminal 100 may select at least one selected artist who satisfies a predetermined criterion based on the results of the conducted survey.

In addition, in an embodiment, the terminal 100 may read out selected artist information, which is artist information about a selected artist, from the memory 110.

In addition, in an embodiment, the terminal 100 may transmit the selected artist information read out to the external server 300.

In addition, in an embodiment, the terminal 100 may acquire gift certificate issuance information, which is predetermined information about a gift certificate issued using an artist image included in the selected artist information as a portrait, from the external server 300.

In addition, in an embodiment, when a gift certificate is produced and issued by the external server 300, the terminal 100 may grant gift certificate purchase authority only to users who participated in the survey and voted for the selected artist.

In addition, in an embodiment, the terminal 100 may provide a predetermined process for trading and managing gift certificates and NFTs matched to the gift certificates provided to at least one user according to the gift certificate purchase authority granted.

According to an embodiment, the terminal 100 may further perform at least a portion of functional operations performed by the service platform server 200, which will be described later.

### Service Platform Server 200

The service platform server 200 according to an embodiment of the present disclosure may perform a series of processes for providing the NFT-linked gift certificate service.

In detail, in an embodiment, the service platform server 200 may provide the NFT-linked gift certificate service by exchanging data necessary to enable for an NFT-linked gift certificate service process to drive in an external device such as the terminal 100 with the external device.

In more detail, in an embodiment, the service platform server 200 may provide an environment in which the application 111 may operate in an external device (in an embodiment, the mobile-type computing device 100-1 and/or the desktop-type computing device 100-2).

To this end, the service platform server 200 may include application programs, data and/or instructions for the application 111 to operate, and may transmit and receive various pieces of data based thereon with the external device.

In addition, in an embodiment, the service platform server 200 may acquire a user verification request to check the qualification for purchasing a gift certificate from the terminal 100.

In addition, in an embodiment, the service platform server 200 may perform verification on a user according to the acquired verification request.

In addition, in an embodiment, the service platform server 200 may execute a purchase and payment process for a gift certificate once verification is completed.

In addition, in an embodiment, the service platform server 200 may acquire issuance information for the paid gift certificate.

In addition, in an embodiment, the service platform server 200 may preset at least one special number (for example, 1, 123, 7777, and the like) that is a specific serial number to be linked to the NFT among the serial numbers included in the gift certificate.

In addition, in an embodiment, the service platform server 200 may issue a predetermined NFT based on the artist information included in the gift certificate.

In addition, in an embodiment, the service platform server 200 may store and manage various application programs, instructions, and/or data for implementing the NFT-linked gift certificate service.

As an example, the service platform server 200 may store and manage at least one or more pieces of artist information, artist digital content, gift certificate issuance information, gift certificate identification information, a predetermined NFT, integrated content, and/or various user interfaces.

However, in an embodiment of the present disclosure, the functional operations that the service platform server 200 may perform are not limited to those described above, and other functional operations may be performed.

Referring further to FIG. 1, in an embodiment, the service platform server 200 as described above may be implemented as a predetermined computing device including at least one processor module 210 for data processing, at least one communication module 220 for data exchange with an external device, and at least one memory module 230 for storing various application programs, data, and/or instructions for providing the NFT-linked gift certificate service.

Herein, the memory module 230 may store one or more of an operating system (OS), various application programs, data, or instructions for providing the NFT-linked gift certificate service.

In addition, the memory module 230 may include the program area and the data area.

Herein, the program area according to an embodiment may be linked between the OS for booting a server and functional elements, and the data area may store data generated according to the use of the server.

In an embodiment, the memory module 230 may be various storage devices, such as a ROM, a RAM, an EPROM, a flash drive, and a hard drive, and may be a web storage performing a storage function of the memory module 230 on the Internet.

In addition, the memory module 230 may be a detachable recording medium on a server.

The processor module 210 may control the overall operation of each unit to implement the NFT-linked gift certificate service.

The processor module 210 may be the SOC suitable for the server that includes the CPU and/or GPU, may execute the OS and/or an application program stored in the memory module 230, and control each component mounted on the server.

In addition, the processor module 210 may communicate with each component internally through a system bus and may include one or more predetermined bus structures including a local bus.

In addition, the processor module 210 may be implemented by using at least one of the ASICS, DSPs, DSPDs, PLDs, FPGAs, controllers, micro-controllers, microprocessors, or electric units for performing other functions.

In the above description, it has been described that the service platform server 200 according to an embodiment of the present disclosure performs the functional operation as described above. However, according to an embodiment, various embodiments may be possible, such as performing at least a portion of the functional operation performed by the service platform server 200 (for example, the terminal 100), and further performing at least a portion of the functional operation performed in the external device in the service platform server 200.

### External Server 300

The external server 300 according to an embodiment of the present disclosure may provide predetermined data that may be utilized on the NFT-linked gift certificate service to the terminal 100 and/or the service platform server 200.

In detail, in an embodiment, the external server 300 may be a server that implements an external service that may support transactions of gift certificates and NFTs matched to the gift certificates (in an embodiment, purchase, sale and/or use of artist-related artist digital content) based on the platform application.

For example, such external servers 300 may include a gift certificate production server 300-1 and/or a cryptocurrency trading platform server 300-2.

In an embodiment, the gift certificate production server 300-1 may be a server that produces and/or issues at least one physical gift certificate (for example, cultural gift certificate) that includes an artist image for a selected artist through a survey.

In an embodiment, the gift certificate production server 300-1 may acquire predetermined artist information from the service platform server 200 and produce a gift certificate based on an artist image included in the acquired artist information.

In addition, in an embodiment, the gift certificate production server 300-1 may generate gift certificate issuance information, which is unique information corresponding to each gift certificate, by producing the gift certificate, and may transmit the generated gift certificate issuance information to the terminal 100 and/or the service platform server 200.

In addition, in an embodiment, the cryptocurrency trading platform server 300-2 may issue an NFT including predetermined artist digital content.

In an embodiment, the NFT may be applied to the artist digital content, and thus may become an object of cryptocurrency trading.

In addition, the predetermined artist digital content collected, owned and managed by each user on the application 111 may be purchased/traded/exchanged on a cryptocurrency exchange by linking with the cryptocurrency trading platform server 300-2.

In an embodiment, the external server 300 as above may include at least one data transmission and reception unit 310, a processor unit 320, or a database 330.

First, the data transmission and reception unit 310 according to an embodiment may transmit and receive various pieces of data for supporting the artist digital content provision service through the network in conjunction with an external device (for example, the terminal 100 and/or the service platform server 200).

As an example, the data transmission and reception unit 310 may transmit and receive external service-based predetermined data (for example, the gift certificate issuance information and/or NFT information) with the user terminal 100 and/or the service platform server 200 through a network.

In addition, the database 330 according to an embodiment may store and manage various pieces of data for supporting the NFT-linked gift certificate service.

In an embodiment, the database 330 may store and manage at least one of the OS, various application programs, data, and instructions for implementing a predetermined external service, and may store and manage predetermined data based on the external service.

These databases may be various storage devices, such as a ROM, a RAM, an EPROM, a flash drive, and a hard drive, and may also be web storage performing a storage function of the database on the Internet.

In addition, the processor unit 320 according to an embodiment may control the overall operation of each component described above for implementing the artist digital content provision service.

The processor unit may be implemented using at least one of the ASICs, the DSPs, the DSPDs, the PLDs, the FPGAs, controllers, micro-controllers, microprocessors, or electric units for performing other functions.

### Method for Issuing NTF by Application

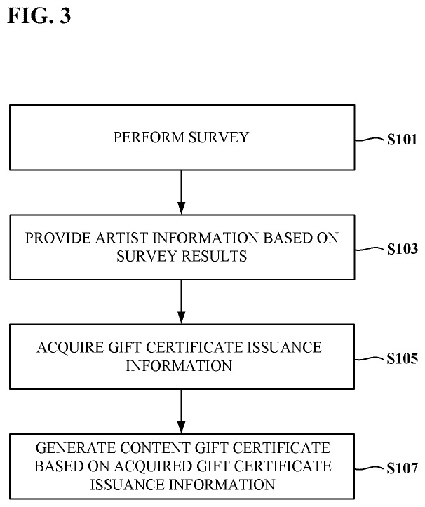

Hereinafter, a method for issuing an NFT to provide an NFT-linked gift certificate service by the application 111 executed by at least one processor of the terminal 100 according to an embodiment of the present disclosure will be described in detail with reference to the attached FIGS. 3 to 9.

In an embodiment of the present disclosure, at least one processor of the terminal 100 may execute at least one application 111 stored in at least one memory 110 or operate the same in a background state.

Hereinafter, the aforementioned method for issuing the NFT by operating at least one processor to execute the instructions of the application 111 is briefly described as performed by the application 111.

FIG. 3 is a flowchart illustrating a method for issuing an NFT according to an embodiment of the present disclosure.

Referring to FIG. 3, in an embodiment, the application 111 executed by at least one processor of the terminal 100 or operating the same a background state may conduct a survey (S101).

Herein, the survey according to an embodiment may be a type of voting performed on the application 111 to determine an artist to be included in a gift certificate according to an embodiment of the present disclosure.

In an embodiment, the application 111 may sense a predetermined user input for a conducted survey.

For example, in an embodiment, a user may perform a user input to select at least one candidate artist (and/or group) to be included in the gift certificate based on the survey, and accordingly, the application 111 in an embodiment may sense the user input.

In this connection, in an embodiment, the application 111 may notify a predetermined notice to users participating in the survey.

For example, in an embodiment, the application 111 may notify that only users who participated in the survey and voted for at least one winning artist are granted the right to purchase gift certificates.

In addition, for example, in an embodiment, the application 111 may notify that voting is possible once a day to prevent hoarding, and that the purchase quantity is determined based on the number of votes.

In addition, according to an embodiment, the application 111 may set predetermined qualification requirements for users participating in the survey.

For example, in an embodiment, the application 111 may set predetermined qualification requirements that allow voting only for artists with fan activity history by linking with a fandom index, which is information indicating the characteristics of various fan activities performed by fan users.

In addition, in an embodiment, the application 111 may provide selected artist information based on the survey results (S103).

Herein, the selected artist according to an embodiment may mean at least one candidate artist (and/or group) whose vote count according to the selection (voting) of a predetermined user satisfies a predetermined criterion (for example, top 10% and/or top 10).

In an embodiment, the application 111 may select at least one selected artist based on the survey results.

In addition, in an embodiment, the application 111 may read out selected artist information, which is artist information about the selected artist, from among at least one piece of artist information stored in advance.

In this connection, the selected artist information according to an embodiment may include an artist (group) name, an artist image, numbers related to an artist (for example, the birthday of the artist and/or the debut date of the artist), and/or artist digital content for at least one selected artist.

In addition, in an embodiment, the application 111 may provide the extracted selected artist information read out as above to the external server 300 (in an embodiment, a gift certificate issuing server 300-1).

In addition, in an embodiment, the application 111 may acquire gift certificate issuance information (S105).

In detail, in an embodiment, the application 111 may acquire at least one piece of gift certificate issuance information generated according to the gift certificate production from the external server 300 that provided the selected artist information.

Herein, the gift certificate issuance information according to an embodiment is unique information corresponding to each gift certificate, and may include face value information, expiration date information, gift certificate identification information (for example, QR code, barcode, and/or serial number), and target artist information.

In this connection, the target artist information according to an embodiment may be one piece of artist information corresponding to one gift certificate among the selected artist information, and one piece of target artist information may be matched for each gift certificate.

The external server 300 according to an embodiment may produce a predetermined number of gift certificates by matching one piece of artist information per gift certificate based on the provided selected artist information, and may generate the gift certificate issuance information corresponding to each of the predetermined number of gift certificates produced.

Accordingly, in an embodiment, the application 111 may acquire gift certificate issuance information generated from the external server 300.

In addition, in an embodiment, the application 111 may generate a content gift certificate based on the acquired gift certificate issuance information (S107).

In detail, in an embodiment, the application 111 may determine whether a first gift certificate includes a special number based on the gift certificate identification information included in the acquired gift certificate issuance information, and generate a predetermined content gift certificate based on the determination.

Herein, the content gift certificate according to an embodiment may be a gift certificate matched with an NFT that includes predetermined artist digital content for the artist targeted by the first gift certificate. These content gift certificates may be gift certificates with NFTs linked to gift certificates including a predetermined special number (hereinafter, “special gift certificates”).

In detail, in an embodiment, the application 111 may determine that the first gift certificate is a special gift certificate when a predetermined serial number included in the acquired gift certificate issuance information matches one of at least one preset special number.

To this end, in an embodiment, the application 111 may set a predetermined serial number as a special number.

Herein, the special number according to an embodiment may be preset based on a randomly set predetermined serial number, QR code and/or barcode and/or a manually set predetermined serial number, QR code and/or barcode according to a user (for example, an administer of the service platform server 200 and/or the application 111) specification.

Hereinafter, the special number is explained based on a predetermined serial number.

In this connection, the special number manually set according to the user specification may be set including when a predetermined condition is satisfied (for example, a first condition including a section configured of one identical number, a second condition including a section configured of consecutive numbers, and/or a third condition including a section configured of anniversary numbers related to a predetermined artist).

For example, in an embodiment, the application 111 may set a serial number such as “777” configured only of one identical number, a serial number such as “123” configured only of consecutive numbers, and/or a predetermined serial number such as “0601” configured of an anniversary number related to an artist included in predetermined selected artist information as a special number.

In addition, in an embodiment, the application 111 may detect target artist information matching the special gift certificate based on the acquired gift certificate issuance information when the first gift certificate includes a special number.

In addition, in an embodiment, the application 111 may extract target digital content based on detected target artist information.

Herein, the target digital content according to an embodiment may be one artist digital content randomly determined and extracted from among at least one piece of artist digital content stored in the memory 110 and corresponding to the target artist information.

In other words, in an embodiment, the application 111 may extract target digital content, which is one piece of artist digital content randomly determined from among at least one artist digital content matching the detected target artist information.

In addition, in an embodiment, the application 111 may generate a pair of NFTs including the extracted target digital content.

Herein, the pair of NFTs according to an embodiment may be an NFT that includes artist digital content stored in response to predetermined artist information and may be an NFT that matches 1:1 with a predetermined special number.

In addition, in an embodiment, the application 111 may link the special number included in the special gift certificate to the generated pair of NFTs.

In other words, in an embodiment, the application 111 may generate a content gift certificate, which is a gift certificate that matches the generated pair of NFTs to the special gift certificate by linking the pair of NFTs and the special number.

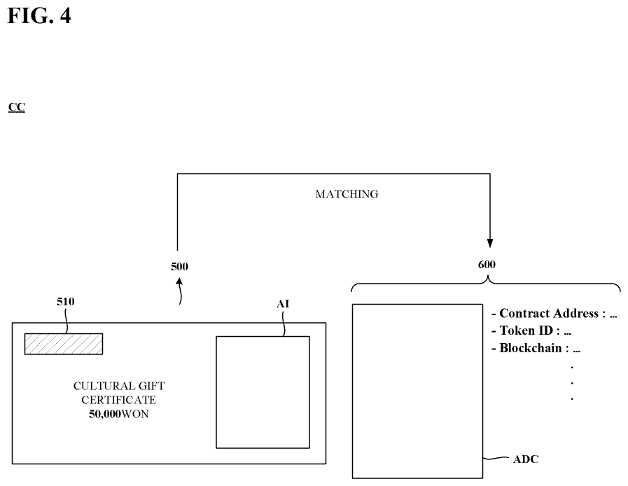

FIG. 4 is a diagram illustrating an example of a content gift certificate according to an embodiment of the present disclosure.

Referring to FIG. 4, in an embodiment, the application 111 may generate a content gift certificate (CC) including a special gift certificate 500 and a pair of NFTs 600 linked to the special gift certificate 500.

In an embodiment, the application 111 may detect target artist information matching the special gift certificate 500 including a special number 510.

In this connection, as illustrated, the special gift certificate 500 according to an embodiment may have a predetermined artist image (AI) included in the matched target artist information printed thereon.

In addition, in an embodiment, the application 111 may extract target digital content based on detected target artist information and generate a pair of NFTs 600 including the extracted target digital content.

In this connection, as illustrated, the pair of NFTs 600 according to an embodiment may include a predetermined artist digital content (ADC) included in the matched target digital content.

In addition, the pair of NFTs 600 may include predetermined NFT detailed data.

In addition, the artist on which the artist image (AI) and the artist digital content (ADC) are based is the same as the target artist. Since the artist digital content (ADC) is randomly determined and matched, the image of the target artist on which the artist digital content (ADC) is based may be different.

As such, in an embodiment, the application 111 may generate at least one content gift certificate (CC) linked to the special gift certificate 500 and the pair of NFTs 600, thereby preventing the indiscriminate generation of NFTs by grafting the NFT onto a visible actual asset.

In an embodiment, such content gift certificates (CC) may be provided to a predetermined user based on the gift certificate purchase right granted only to users who participated in a survey according to an embodiment and voted for the target artist of the content gift certificate (CC).

In other words, in an embodiment, the application 111 may deliver a random gift certificate including the content gift certificate (CC) to a user through a predetermined payment and delivery process, and may provide the NFT-linked gift certificate service that stores and manages at least one content gift certificate (CC) belonging to the user through a predetermined verification process.

### Method for Providing NFT-Linked Gift Certificate Service

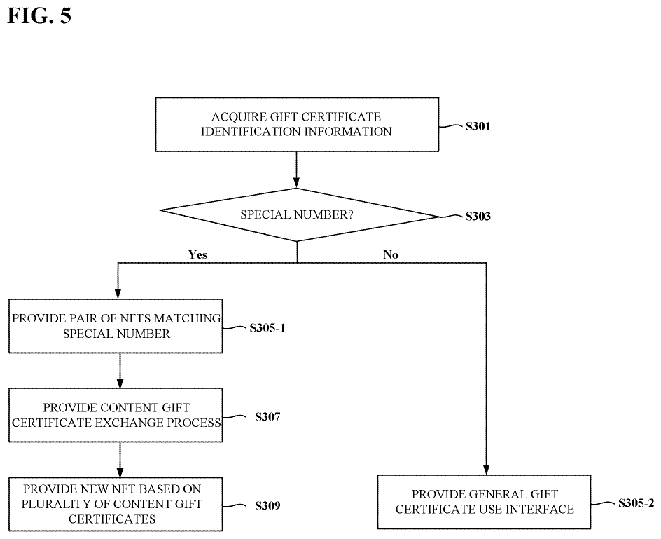

FIG. 5 is a flowchart illustrating a method for providing an NFT-linked gift certificate service according to an embodiment of the present disclosure.

Referring to FIG. 5, in an embodiment, the application 111 may acquire gift certificate identification information (S301).

In detail, in an embodiment, the application 111 may acquire gift certificate identification information based on a predetermined user input regarding a gift certificate provided to a user (in other words, a gift certificate purchaser in an embodiment).

Although it has been described above that the gift certificate identification information according to an embodiment includes a QR code, a barcode, and/or a serial number, the following description will be made based on the gift certificate identification information being a serial number for convenience of explanation.

In addition, a user according to an embodiment may purchase a predetermined gift certificate as a reward for participating in a survey and randomly receive at least one physical gift certificate among a general gift certificate and/or a content gift certificate (CC).

In addition, a user according to an embodiment may perform an input to log in to a platform that provides the NFT-linked gift certificate service to check whether a randomly sent gift certificate corresponds to a content gift certificate (CC).

In an embodiment, the application 111 may acquire the serial number by sensing a user input directly entering the serial number included in a predetermined gift certificate received by the user when login according to a user account is approved.

In addition, in an embodiment, the application 111 may acquire a serial number by sensing a captured image and/or video input of a predetermined gift certificate received by a user.

To this end, in an embodiment, the application 111 may input a gift certificate image and/or video captured by the image sensor 161.

In addition, in an embodiment, the application 111 may sense the serial number displayed on the gift certificate based on the input gift certificate image and/or video.

In addition, the application 111 may acquire the serial number included in the gift certificate image and/or video by extracting the sensed serial number.

In addition, in an embodiment, the application 111 may store the acquired gift certificate image and serial number by matching the same to the user account.

Accordingly, the application 111 may easily check and manage the owner of each general gift certificate and/or content gift certificate (CC) provided above.

In addition, in an embodiment, the application 111 may discriminate the content gift certificate based on the acquired gift certificate identification information (S303).

In detail, in an embodiment, the application 111 may discriminate the content gift certificate based on whether the acquired serial number matches one of at least one preset special number.

In this connection, in an embodiment, when the acquired serial number matches a predetermined special number, the application 111 may determine that the gift certificate is a content gift certificate (CC) and perform stage S305-1.

In an embodiment, when the acquired serial number does not match a predetermined special number, the application 111 may determine that the gift certificate is a general gift certificate and perform stage S305-2.

In an embodiment, the application 111 may provide a pair of NFTs matching the special number (S305-1).

In detail, in an embodiment, the application 111 may provide a pair of NFTs matched to a content gift certificate (CC) generated through the aforementioned stages S101 to S109 including the special number.

In this connection, in an embodiment, the application 111 may store and manage the provided pair of NFTs 600 by matching the same to the user account.

To sum up, in an embodiment, the application 111 may store and manage at least one acquired gift certificate (general gift certificate and/or content gift certificate (CC)) image, serial number, and pair of NFTs by matching the same to the user account.

Thus, the application 111 may check the actual owner of each randomly sent gift certificate, smoothly provide basic data that may be required for various user services utilizing the same, and also allow users (in other words, purchasers) to easily manage their random gift certificates not only in actual form but also online by linking the same to their platform account.

To this end, in an embodiment, the application 111 may provide a collecting interface (CI) that may manage (for example, view/sell/use) at least one content gift certificate (CC) and/or pair of NFTs matched and stored in the user account in a predetermined manner.

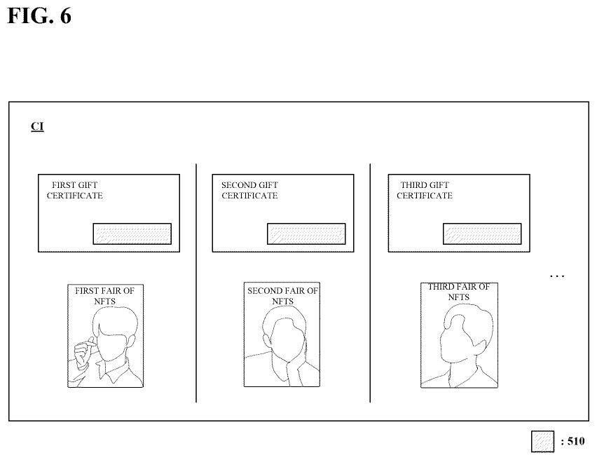

FIG. 6 is an example of a gift certificate collecting interface according to an embodiment of the present disclosure.

Referring to FIG. 6, in an embodiment, the application 111 may display and output at least one content gift certificate (CC) and/or pair of NFTs stored in conjunction with a user account as described above based on the provided collecting interface (CI) in a predetermined manner (for example, a list of content gift certificates by artist and/or a list of pair of NFTs by artist).

In this connection, in an embodiment, the application 111 may activate predetermined artist digital content included in the pair of NFTs for each gift certificate stored in the user account based on the collecting interface (CI).

In detail, in an embodiment, the application 111 may activate artist digital content (for example, moving image playback and/or artist voice and sound source playback) uniquely implemented through the pair of NFTs.

In addition, in an embodiment, the application 111 may check the ownership status of a predetermined collection based on the collecting interface (CI).

In detail, in an embodiment, the application 111 may check the ownership status of a collection (for example, a collection of predetermined serial numbers and/or a collection of predetermined artist (group) images) including at least one content gift certificate (CC) and/or pair of NFTs that satisfies predetermined conditions.

In addition, in an embodiment, the application 111 may provide the current price and market price of the pair of NFTs for each gift certificate stored in the user account by linking with the external server 300 (in an embodiment, the cryptocurrency trading platform server 300-2).

In other words, in an embodiment, the application 111 may support a user to collectively check and manage all gift certificates owned by the user through a single user interface (the collecting interface (CI) in an embodiment), thereby increasing the usability and utilization of gift certificates and NFTs owned by the user.

In an embodiment, the application 111 may change or extinguish the owner of a predetermined content gift certificate (CC) and its matching pair of NFTs by providing a predetermined process that may trade and/or use at least one content gift certificate (CC) stored in the user account.

To this end, in an embodiment, the application 111 may provide a content gift certificate exchange process (S307-1).

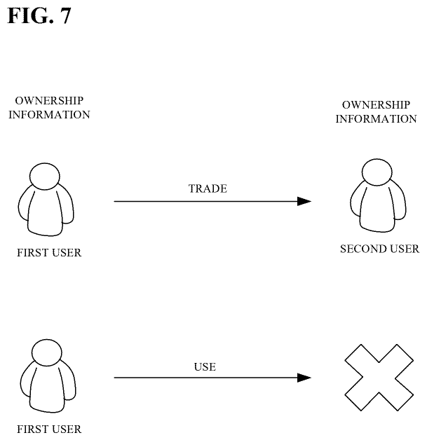

FIG. 7 is an example of a diagram illustrating a content gift certificate exchange process according to an embodiment of the present disclosure.

Referring to FIG. 7, in an embodiment, the application 111 may provide a content gift certificate exchange process that changes and/or discards ownership information for at least one content gift certificate (CC) and pair of NFTs stored and matched to the user account according to a transaction and/or use of a predetermined content gift certificate (CC).

In other words, a user according to an embodiment may purchase the content gift certificate (CC) directly from the platform as a reward for participating in a survey, but may also acquire and manage at least one content gift certificate (CC) through a transaction between users based on the content gift certificate exchange process.

In an embodiment, the application 111 may provide the content gift certificate exchange process that updates the ownership information of the traded content gift certificate (CC) and the pair of NFTs according to the transaction for the predetermined content gift certificate (CC).

To this end, in an embodiment, the application 111 may sense a predetermined user input for verifying a transaction after performing a physical transaction for the predetermined content gift certificate (CC). Hereinafter, for convenience of explanation, the user who sold the predetermined content gift certificate (CC) may be referred to as a first user, and the user who purchased the predetermined content gift certificate (CC) may be referred to as a second user.

In this connection, in an embodiment, the application 111 may be configured such that the predetermined user input for verifying the transaction may be input from at least one of the users who performed the transaction (in an embodiment, the first user and the second user), and when the input is sensed, the transaction verification may be automatically applied to a transaction counterparty.

In an embodiment, when a transaction is verified, the application 111 may change the ownership information of a first content gift certificate traded and the first pair of NFTs matched therewith from the first user to the second user based on the content gift certificate exchange process.

In addition, in an embodiment, the application 111 may change the information (hereinafter, user account information) stored and matched to each user account as the owner information is updated.

In detail, in an embodiment, the application 111 may change first user account information of the first user who sold the first content gift certificate and second user account information of the second user who purchased the first content gift certificate as the owner information is updated.

In more detail, in an embodiment, the application 111 may change predetermined user account information by deleting the first content gift certificate included in the first user account information and adding the first content gift certificate to the second user account information as the owner information is updated.

In addition, in an embodiment, the application 111 may provide a content gift certificate exchange process that discards the ownership information of the used content gift certificate (CC) and the pair of NFTs according to the use of the predetermined content gift certificate (CC). Hereinafter, for convenience of explanation, the user who used the predetermined content gift certificate (CC) may be referred to as the first user.

To this end, in an embodiment, the application 111 may acquire predetermined data for verifying online and/or offline use of the predetermined content gift certificate (CC) based on the service platform server 200 and/or a predetermined external server (for example, an online shopping mall server).

In an embodiment, when use is verified, the application 111 may discard the ownership information of the first content gift certificate used and the first pair of NFTs matched therewith based on the content gift certificate exchange process.

In addition, the application 111 may extinguish the first pair of NFTs matched to the first content gift certificate.

In this connection, the owner information of the existing first content gift certificate and the first pair of NFTs matching the same may have been the first user.

In addition, in an embodiment, the application 111 may change the predetermined user account information by deleting the first content gift certificate included in the first user account information as the owner information is discarded.

In an embodiment, the application 111 may provide a function of providing a reward (in an embodiment, a new NFT) by combining a plurality of content gift certificates (CC) stored in conjunction with the user account as described above according to predetermined criteria.

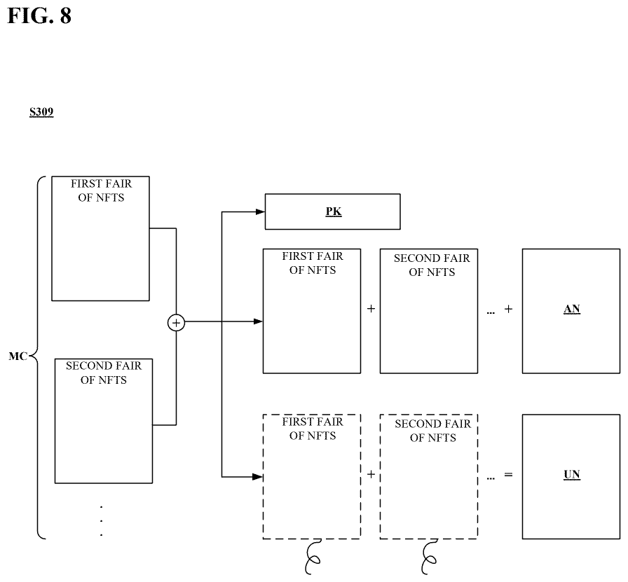

FIG. 8 is an example of a diagram illustrating a method for providing a new NFT according to an embodiment of the present disclosure.

Referring to FIG. 8, in an embodiment, the application 111 may provide a new NFT based on a plurality of content gift certificates (S309).

In detail, in an embodiment, the application 111 may provide the new NFT based on the plurality of content gift certificates according to preset new NFT reward conditions.

Herein, the new NFT reward conditions according to an embodiment may include conditions for a predetermined number of content gift certificates, a predetermined set of serial numbers, and/or conditions for collecting all sets of images for each artist within a predetermined artist group (for example, a collection of images for all members of group A and/or a collection of images for all versions/concepts of artist B).

In addition, the new NFT according to an embodiment may be an NFT newly provided based on a plurality of content gift certificates and/or a plurality of pairs of NFTs (hereinafter, a plurality of pieces of material content) matching the plurality of content gift certificates.

In this connection, the new NFT according to an embodiment may be at least one of an additional NFT and/or an higher-level NFT.

The additional NFT may include one target artist digital content randomly determined from among at least one piece of target artist digital content already stored for the target artist matching the content gift certificate and pair of NFTs already owned by a user.

In addition, the higher-level NFT may include one piece of randomly determined target artist digital content among target artist digital content with predetermined upgraded content components for the same target artist.

In other words, the additional NFT may be provided regardless of whether the content component is upgraded when the target is the same as the target artist, and the higher-level NFT may be provided as an NFT with an upgraded content component compared to a predetermined pair of NFTs that a user presently owned.

In other words, in an embodiment, such a predetermined new NFT may include an additional NFT that is additionally provided to content gift certificates and pair of NFTs already owned when the new NFT reward conditions are satisfied, and/or an higher-level NFT that is provided by extinguishing a predetermined pair of NFTs that satisfies the new NFT reward conditions among the content gift certificates and pair of NFTs already owned when the new NFT reward conditions are satisfied.

In other words, in an embodiment, the application 111 may provide a predetermined new NFT by collecting a plurality of content gift certificates (CC) that meet preset new NFT reward conditions and/or a plurality of pair of NFTs 600 that match the same.

In an embodiment, the application 111 may provide an additional NFT (AN) and/or a predetermined privilege (PK: for example, an offline fan meeting admission ticket and/or a concert ticket purchase ticket) to an NFT already owned by a user when a plurality of content gift certificates (CC) stored in conjunction with the user account meet a predetermined new NFT reward condition.

In addition, in an embodiment, when a plurality of content gift certificates (CC) stored in conjunction with the user account meet predetermined new NFT reward conditions, the application 111 may combine the same to extinguish all NFTs already owned by a user and provide an higher-level NFT (UN). There may be various embodiments in which these higher-level NFTs may be provided additionally without extinguishing NFTs already owned by the user.

Herein, the higher-level NFT according to an embodiment may mean an NFT that adds predetermined content to each element of the artist digital content included in the plurality of pieces of material contents (MC) used in the combination (in an embodiment, each element included in the main content and the sub-content, and each of these elements may be preset to a default value when first provided to a predetermined user) or improves the quality of existing content.

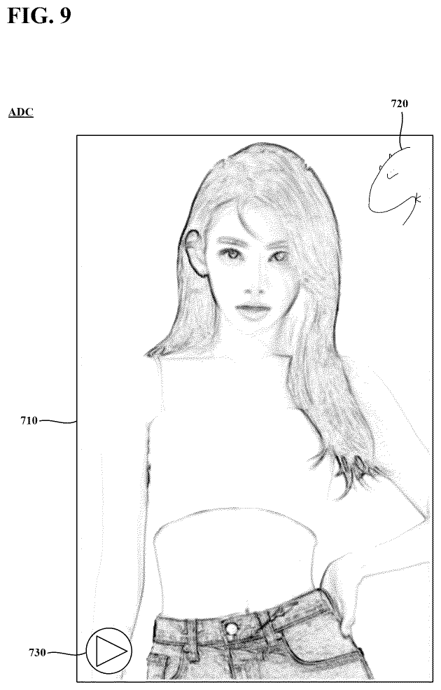

FIG. 9 is an example of artist digital content according to an embodiment of the present disclosure.

Referring to FIG. 9, the artist digital content (ADC) may include at least one piece of content among an artist image 710, a text 720, and auditory 730.

In an embodiment, the artist digital content (ADC) may include an artist image 710 as main content and at least one of the text 720 or the auditory 730 as sub-content.

In detail, in an embodiment, first artist digital content may include one piece of main content and at least one piece of sub-content.

In an embodiment, the artist image 710 included in the artist digital content (ADC) may be an image of an individual artist and/or a group of artists that represent the appearance of the artist, for example, a photo, video, or drawing (for example, a caricature) of the artist.

In addition, in an embodiment, the text 720 may be numbers and letters that are displayed overlaid on the artist image 710. For example, the text 720 may include an album name of an artist, the name of an individual artist and/or group, and an anniversary. In addition, the text 720 may include an image of text handwritten by an artist.

In addition, in an embodiment, the text 720 may be configured of a font specified by a user and/or an administrator, or a font containing the actual handwriting of an artist.

In addition, in an embodiment, the auditory 730 may mean content output as audio when a user inputs an affordance for selecting whether to output the auditory on the artist image 710. For example, the auditory 730 may include a portion of a sound source of an artist and a voice message consisting of the voice of the artist.

In an embodiment, the application 111 may provide the artist digital content (ADC) to a predetermined user as an NFT including the artist digital content with each element set to a default value when first provided to the user.

In addition, in the embodiment, the application 111 may provide an higher-level NFT that increases the level of each element included in the plurality of pieces of material contents (MC) through collection and combination (reinforcement/synthesis).

The elements according to an embodiment may include the resolution and video playback length of the artist image 710 included in the main content of the artist digital content (ADC), the number of texts 720 included in the sub-content, and the sound quality and audio playback length of the attributes and auditory 730.

More specifically, the elements may include a first element for the resolution of the main content, a second element for the video playback length of the main content, a third element for the number of texts 720 of the sub-content, a fourth element for the attributes of the texts 720 of the sub-content, a fifth element for the sound quality of the auditory 730 of the sub-content, and a sixth element for the audio playback length of the auditory 730 of the sub-content.

In other words, in an embodiment, the application 111 may provide an higher-level NFT with the stage of the first to sixth elements increased according to collection and combination (reinforcement/synthesis).

To this end, in an embodiment, the application 111 may set predetermined detailed stages (for example, stages 1 to 10) for each of the first to sixth elements.

In this connection, the detailed stages may be such that the first stage may be the attribute with the lowest quality/quantity, and the tenth stage may be the attribute with the highest quality/quantity. In addition, the first stage may be a stage designated as default.

In detail, in an embodiment, the application 111 may set a first stage with the lowest resolution to a tenth stage with the highest resolution in the first element for the resolution of the main content.

In addition, in an embodiment, the application 111 may establish the case where the artist image 710 included in the main content is a fixed image that does not move as the first stage in the second element for the video playback length of the main content, and may establish the second stage with the shortest video playback length to the tenth stage with the longest video playback length.

In addition, in an embodiment, the application 111 may establish the first stage with 0 texts 720 to the tenth stage with 10 texts 720 in the third element for the number of texts 720 of the sub-content.

In addition, in an embodiment, the application 111 may establish the first stage in which 0 attributes are added to the text 720 in the fourth element for the attributes of the text 720 of the sub-content to the tenth stage in which 10 attributes are added to the text 720. In this connection, attributes added to the text 720 may include font upgrades, font size upgrades, and addition of effects (for example, sparkles and movements).

In addition, in an embodiment, the application 111 may establish the fifth element of the sound quality of the auditory 730 of the sub-content from the first stage with the lowest sound quality to the tenth stage with the highest sound quality of the auditory 730.

In addition, in an embodiment, the application 111 may establish, in the sixth element for the audio playback length of the auditory 730 of the sub-content, the first stage having the shortest audio playback length to the tenth stage having the longest audio playback length of the auditory 730.

In other words, in an embodiment, the application 111 may extinguish a plurality of pieces of material contents (MC) in which the first to sixth elements are set to the first stage when a predetermined new NFT reward condition is met, and randomly determine and provide an higher-level NFT in which the first to sixth elements are set to the second stage or higher.

In this connection, the randomly determined and provided higher-level NFT may be an higher-level NFT that has the same predetermined information (for example, artist information) included in the plurality of pieces of material contents (MC), but has only a different stage of the predetermined element.

In addition, in an embodiment, the application 111 may set a predetermined continuation condition that needs to continuously maintain the new NFT reward condition when a new NFT is provided by satisfying the new NFT reward condition.

For example, the continuation condition may be a condition that requires that when 10 content gift certificates are collected and a new NFT is acquired, the 10 content gift certificates need to be matched and stored in the user account.

In this connection, in an embodiment, the application 111 may change the status of the provided new NFT when sensing that the set predetermined continuation condition is not satisfied (for example, processing of exchange (transaction/use) of at least one content gift certificate (CC) and/or pair NFT).

In detail, in an embodiment, when the application 111 senses that the set predetermined continuation condition is not satisfied, 1) the state of the provided new NFT may be changed by discarding the provided new NFT.

In addition, in an embodiment, the application 111 may change the predetermined user account information by deleting the new NFT included in the first user account information of the first user who was provided with the new NFT as the new NFT is discarded.

In addition, in an embodiment, when the application 111 senses that the set predetermined continuation condition is not satisfied, 2) the state of the provided new NFT may be changed by downgrading each element of the artist digital content included in the provided new NFT.

To this end, in an embodiment, the application 111 may randomly select at least one element from among the first to sixth elements included in the new NFT.

In addition, in an embodiment, the application 111 may reduce the stages set for the selected element by at least one stage.

For example, in an embodiment, the application 111 may reduce the audio playback length of the artist digital content included in the new NFT from stage 10 to stage 1.

In addition, in an embodiment, when the application 111 senses that the set predetermined continuation condition is not satisfied, 3) the state of the provided new NFT may be changed by removing each element of the artist digital content included in the provided new NFT.

As such, to this end, the application 111 in an embodiment may randomly select at least one element from among the first to sixth elements included in the new NFT.

In addition, in an embodiment, the application 111 may remove the selected element. In this connection, the predetermined elements selected and removed may be limited to sub-content (for example, text 720 and/or auditory 730).

For example, referring again to FIG. 9, in an embodiment, the application 111 may remove the text 720 included in the artist digital content (ADC) included in the new NFT.

In the above manner, the application 111 in an embodiment may improve user satisfaction by providing new NFTs of improved quality based on a plurality of content gift certificates and may stimulate the user's desire to collect by changing the attributes of the new NFTs, thereby activating the gift certificate and NFT trading market.

In an embodiment, when it is determined that a predetermined gift certificate owned by a user is a general gift certificate through stage S303, the application 111 may provide a general gift certificate use interface (S305-2).

In this connection, the general gift certificate use interface according to an embodiment may be an interface that provides a service that allows a user to use goods and/or services equivalent to the face value of a predetermined general gift certificate owned by the user online and/or offline.

For example, in an embodiment, the application 111 may provide a list of offline gift certificate usage locations or a list of online gift certificate usage locations (for example, gift certificate shops and online Kyobo Bookstore) based on predetermined information (for example, address information) entered by a user when registering as a member.

Hereinbefore, a method and system for providing an NFT-linked gift certificate service according to an embodiment of the present disclosure can instill in consumers the perception that an NFT is not intangible data without substance by grafting the same onto a visible actual asset, thereby enhancing consumers' interest and curiosity in the NFT and actual assets, and simultaneously lowering the barrier to the NFT, thereby increasing the NFT transaction rate and activating the NFT market.

In addition, the method and system for providing the NFT-linked gift certificate service according to an embodiment of the present disclosure can increase environmental/financial efficiency in the production of goods by issuing a limited number of gift certificates according to demand, thereby preventing additional expenses and losses that may occur due to unnecessary production of fewer or more.

In addition, the method and system for providing the NFT-linked gift certificate service according to an embodiment of the present disclosure can easily understand and manage the owner of the issued NFT, thereby enabling prompt response in the event of issues such as changes in the status of the issued NFT and/or copyright disputes in the future.

In addition, the method and system for providing the NFT-linked gift certificate service according to an embodiment of the present disclosure can prevent destruction of the analog and digital environment by blockchain mining equipment and blockchain facilities by avoiding indiscriminate generation of NFTs, and maintain excellent quality of NFTs, thereby enhancing reliability in the NFT market.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

### INDUSTRIAL APPLICABILITY

An embodiment of the present disclosure provides an NFT-linked service through a terminal in conjunction with a gift certificate, and thus has industrial applicability.

What is claimed is:

1. A method for providing an NFT-linked gift certificate service, in which an application executed by at least one processor of a terminal provides the NFT-linked gift certificate service, the method comprising:
performing a survey to determine a target artist for which a gift certificate is matched;
generating a content gift certificate matched with a pair of NFTs containing digital content for the determined target artist;
providing the generated content gift certificate in a random manner;
acquiring gift certificate identification information specifying a predetermined first gift certificate;
determining whether the first gift certificate is the content gift certificate based on the acquired gift certificate identification information; and
providing the pair of NFTs matched to the content gift certificate online when the first gift certificate is the content gift certificate.

2. The method of claim 1, wherein the content gift certificate is an actual gift certificate in which a serial number that specifies the content gift certificate matches a preset special number.

3. The method of claim 2, wherein the generation of the content gift certificate matched with the pair of NFTs containing the digital content for the determined target artist comprises:
setting a special gift certificate to which the special number is given; and
matching the pair of NFTs to the special number of the set special gift certificate.

4. The method of claim 3, wherein the matching of the pair of NFTs comprises:
randomly selecting one of a plurality of pieces of digital content for the target artist; and
generating the pair of NFTs based on the randomly selected digital content.

5. The method of claim 1, wherein the performance of the survey to determine the target artist for which the gift certificate is matched comprises:
acquiring a user input to vote for at least one artist among a plurality of candidate artists;
determining at least one candidate artist whose vote count according to the user vote satisfies a predetermined criterion as a selected artist; and
determining one of the at least one selected artist as the target artist.

6. The method of claim 5, wherein the provision of the generated content gift certificate in a random manner comprises:
verifying a user who voted for the target artist; and
randomly providing at least gift certificate among the content gift certificates matched with the pair of NFTs and a general gift certificate unmatched with the pair of NFTs upon being verified as the user who voted for the target artist.

7. The method of claim 6, wherein the provision of the pair of NFTs matched to the content gift certificate online when the first gift certificate is the content gift certificate comprises:
matching the provided pair of NFTs to a user account; and
setting ownership information for the pair of NFTs based on the pair of NFTs matched to the user account.

8. The method of claim 7, further comprising providing an exchange process for processing a transaction or use of the content gift certificate.

9. The method of claim 8, wherein the provision of the exchange process comprises changing or discarding the ownership information for the pair of NFTs matched to the traded or used content gift certificate.

10. The method of claim 1, further comprises providing a new NFT based on a plurality of content gift certificates,
wherein the provision of the new NFT comprises at least one of:
determining whether a preset new NFT reward condition is satisfied;
maintaining a plurality of a pair of NFTs according to the plurality of content gift certificates and providing an additional NFT that is provided when the new NFT reward condition is satisfied; or
deleting the plurality of the pair of NFTs and providing a higher-level NFT that is provided.

11. The method of claim 10, wherein the additional NFT comprises digital content for a target artist that matches at least some of the plurality of content gift certificates, and the higher-level NFT comprises digital content in which at least one component of a pair of NFTs that matches at least some of the plurality of content gift certificates is upgraded.

12. A system for providing an NFT-linked gift certificate service, the system comprising:
at least one memory in which a platform application is stored; and
at least one processor for reading out the platform application stored in the memory and providing the NFT-linked gift certificate service, wherein instructions of the platform application comprises instructions for:
performing a survey to determine a target artist for which a gift certificate is matched;
generating a content gift certificate matched with a pair of NFTs containing digital content for the determined target artist;
providing the generated content gift certificate in a random manner;
acquiring gift certificate identification information specifying a predetermined first gift certificate;
determining whether the first gift certificate is the content gift certificate based on the acquired gift certificate identification information; and
providing the pair of NFTs matched to the content gift certificate online when the first gift certificate is the content gift certificate.
